(19) United States
(12) Patent Application Publication
(10) Pub. No.: US 2016/0319695 A1
(43) Pub. Date: Nov. 3, 2016

(54) SYSTEM AND METHODS FOR DETERMINING BLADE CLEARANCE FOR ASYMMERTIC ROTORS

(71) Applicants: Joshua D. ISOM, Allentown, PA (US); Clifford PAWELCIK, Glastonbury, CT (US); Bruce HOCKADAY, Vernon, CT (US)

(72) Inventors: Joshua D. ISOM, Allentown, PA (US); Clifford PAWELCIK, Glastonbury, CT (US); Bruce HOCKADAY, Vernon, CT (US)

(73) Assignee: United Technologies Corporation, Farmington, CT (US)

(21) Appl. No.: 15/109,055

(22) PCT Filed: Dec. 19, 2014
(86) PCT No.: PCT/US14/71562

§ 371 Date: Jun. 29, 2016

Related U.S. Application Data
(60) Provisional application No. 61/922,443, filed on Dec. 31, 2013.

(51) Int. Cl. F01D 21/00; F01D 5/12; G01B 7/14; G01D 5/24; G01B 7/02; G01B 21/16

(52) U.S. Cl. CPC F01D 21/003; G01B 7/023; G01B 21/16; G01B 7/14; G01D 5/24; F01D 5/12; F05D 2220/32; F05D 2240/307

(57) ABSTRACT

A system and methods are provided for determining blade clearance for asymmetrical rotors. In one embodiment, a method includes detecting displacement data of a rotor blade coupled to a shaft, receiving tachometer data determined for rotation speed of the shaft, and resampling the displacement data of the rotor blade based on the tachometer data. Resampling may include sampling the displacement data at constant increments of shaft rotation. The method may also include determining blade clearance based on the resampled displacement data.

### CROSS-REFERENCE TO RELATED APPLICATIONS

This application claims priority to U.S. Provisional Application No. 61/922,443 filed on Dec. 31, 2013 and titled System and Methods for Determining Blade Clearance for Asymmetric Rotors, the disclosure of which is hereby incorporated by reference in its entirety.

### FIELD

The present disclosure relates generally to design and validation of gas turbine engines, and more particularly to a system and methods for determining blade clearance for asymmetric rotors.

### BACKGROUND

The determination of the tip clearance of blades in a gas turbine engine is important for gas turbine engines. Several different types of noncontact sensors may be used to generate a signal which is sensitive to the displacement of a rotor blade. When turbine blades have a symmetric spacing, blade clearance can be monitored in the frequency domain as a function of the amplitude of the blade pass frequency. Some recently designed engines have asymmetric blade spacing to produce decreased levels of vibration excitation at specific frequencies. The conventional methods of detection and signal processing system for symmetric blades does not work for asymmetrically spaced blades. Accordingly, there is a desire to provide determination of blade clearance for asymmetric rotors.

### BRIEF SUMMARY OF THE EMBODIMENTS

Disclosed and claimed herein are a system and methods for determining blade clearance for asymmetrical rotors. In one embodiment, a method includes detecting displacement data of a rotor blade coupled to a shaft and receiving tachometer data determined for rotation speed of the shaft. The method also includes resampling the displacement data of the rotor blade based on the tachometer data, wherein resampling includes sampling the displacement data at constant increments of shaft rotation, and determining blade clearance based on the resampled displacement data.

In one embodiment, a system for determining blade clearance for asymmetrical rotors includes a displacement sensor configured to detect displacement data of a rotor blade coupled to a shaft, a tachometer configured to output tachometer data for rotation speed of the shaft, and an analysis unit coupled to the displacement sensor and tachometer. According to one embodiment, the analysis unit is configured to resample the displacement data of the rotor blade based on the tachometer data, wherein resampling includes sampling the displacement data at constant increments of shaft rotation, and output an indication of blade clearance based on the resampled displacement data.

Other aspects, features, and techniques will be apparent to one skilled in the relevant art in view of the following detailed description of the embodiments.

### BRIEF DESCRIPTION OF THE DRAWINGS

The features, objects, and advantages of the present disclosure will become more apparent from the detailed description set forth below when taken in conjunction with the drawings in which like reference characters identify correspondingly throughout and wherein:

FIG. 1 depicts a simplified system diagram of a system for determining blade clearance for asymmetrical rotors according to one or more embodiments;

FIG. 2 depicts a method for determining blade clearance for asymmetrical rotors according to one or more embodiments;

FIG. 3 depicts a graphical representation for indicating blade clearance according to one or more other embodiments;

FIG. 4 depicts a graphical representation of displacement sensor output according to one or more other embodiments;

FIG. 5 depicts a graphical representation of tachometer data according to one or more embodiments;

FIG. 6 depicts a graphical representation of waveforms according to one or more embodiments; and

FIG. 7 depicts a graphical representation of moving synchronous average standard deviation according to one or more embodiments.

### DETAILED DESCRIPTION OF THE EXEMPLARY EMBODIMENTS

### Overview and Terminology

One aspect of the disclosure relates to determining the clearance of blades in a gas turbine engine. In one embodiment, a method for determining the clearance of blades in a gas turbine engine includes. Angular resampling of may be performed for the displacement data using the tachometer data in order to determine blade clearance.

According to another embodiment, a system for determining the clearance of blades in a gas turbine engine includes a displacement sensor, tachometer and analysis unit. The analysis unit may be configured to determine blade clearance based on angular resampling of displacement data using tachometer data.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation.

### Exemplary Embodiments

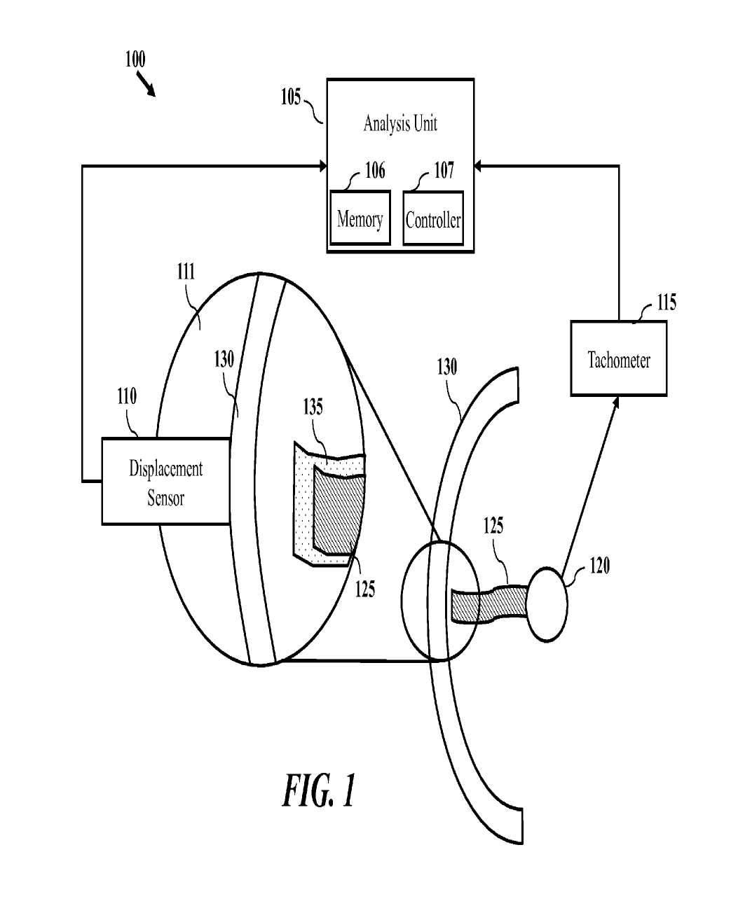

Referring now to the figures, FIG. 1 depicts a simplified system diagram of a system for determining blade clearance for asymmetrical rotors according to one or more embodiments. According to one embodiment, system 100 may include analysis unit 105 electrically coupled to displacement sensor 110 and tachometer 115. Analysis unit may be configured to determine blade clearance for asymmetric rotors based on data received from displacement sensor 110 and tachometer 115.

According to one embodiment, system 100 may be configured to determine blade clearance for rotors of a gas turbine engine with asymmetrical rotors. As shown in FIG. 1, a partial portion of a gas turbine engine is represented by shaft 120, rotor blade 125 and casing 130. Displacement sensor 105 may be configured to detect displacement data of rotor blade 125 coupled to shaft 120 as shown in enlarged window area 111. In one embodiment, displacement sensor 105 is a capacitive sensor. Displacement of rotor blade 125 is represented by 135 in FIG. 1, which may be due to vibration, thermal expansion of rotor 125, etc. Displacement sensor 105 may determine blade length measurement data. In certain embodiments, displacement data for rotor blade 125 is instantaneous displacement data of the rotor blade determined by a capacitive sensor, such as displacement sensor 110.

Tachometer 115 may be configured to output data for rotation speed of shaft 120. Tachometer 120 may produce pulses at regular intervals.

Analysis unit 105 may include memory 106, such as RAM or Rom memory configured to store data and controller 107 configured to process data and one or more executable instructions. According to one embodiment, analysis unit 105 may be configured to resample received displacement data of the rotor blade based on the tachometer data and output an indication of blade clearance based on the resampled displacement data.

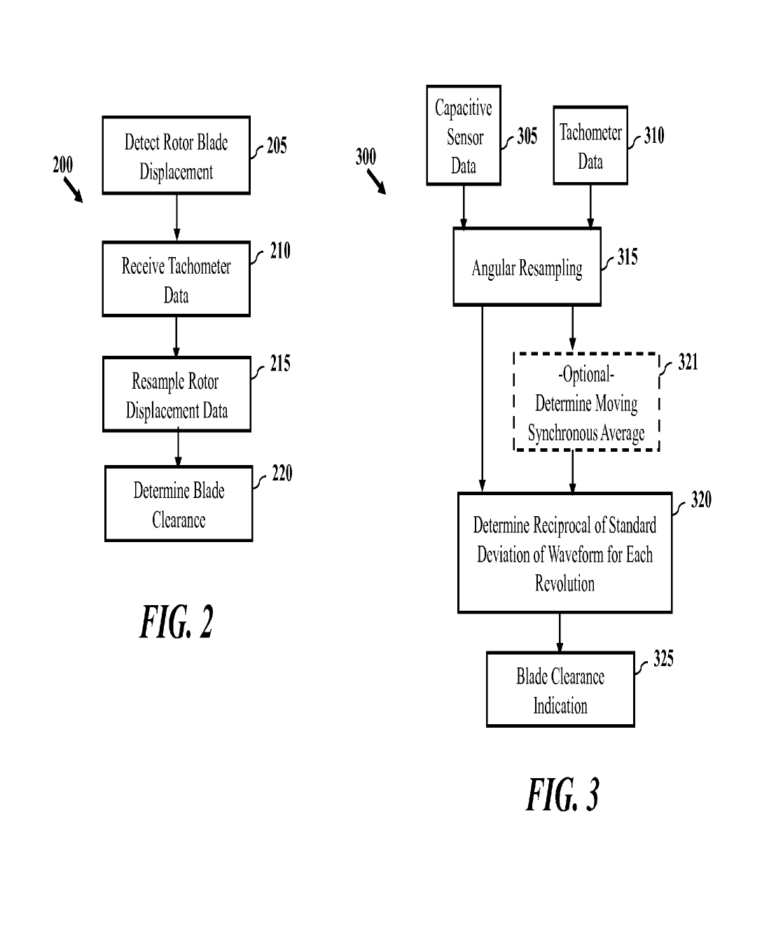

FIG. 2 depicts a process for determining blade clearance for asymmetrical rotors according to one or more embodiments. According to one embodiment, process 200 may be employed by an analysis unit (e.g. analysis unit 105) of a system for determining blade clearance for asymmetrical rotors.

Process 200 may be initiated at block 205 with detecting displacement data of a rotor blade coupled to a shaft. Displacement data determined for the rotor blade can include blade length measurement data. The displacement data for the rotor blade may be instantaneous rotor blade displacement data determined by a capacitive displacement sensor.

At block 210, tachometer data determined for rotation speed of the shaft may be received. The tachometer data is determined by a tachometer producing pulses at regular intervals. The displacement data of the rotor blade may be resampled based on the tachometer data at block 215. Resampling can include sampling the displacement data at constant increments of shaft rotation. According to one embodiment, the resampling may be angular resampling to generate a resampled waveform for each revolution of the rotor blade based on one or more of determining zero up-crossings for the tachometer data, determining an angle of shaft of interest at each up-crossing, interpolating up-crossing angles to find shaft angle at all original sample times, and interpolating the signal at equal angular increments.

At block 220 blade clearance may be determined based on the resampled displacement data. The displacement data for the rotor blade may be output for control of a gas turbine engine. Blade clearance may further be based on a moving synchronous average as will be discussed in more detail below with reference to FIG. 3.

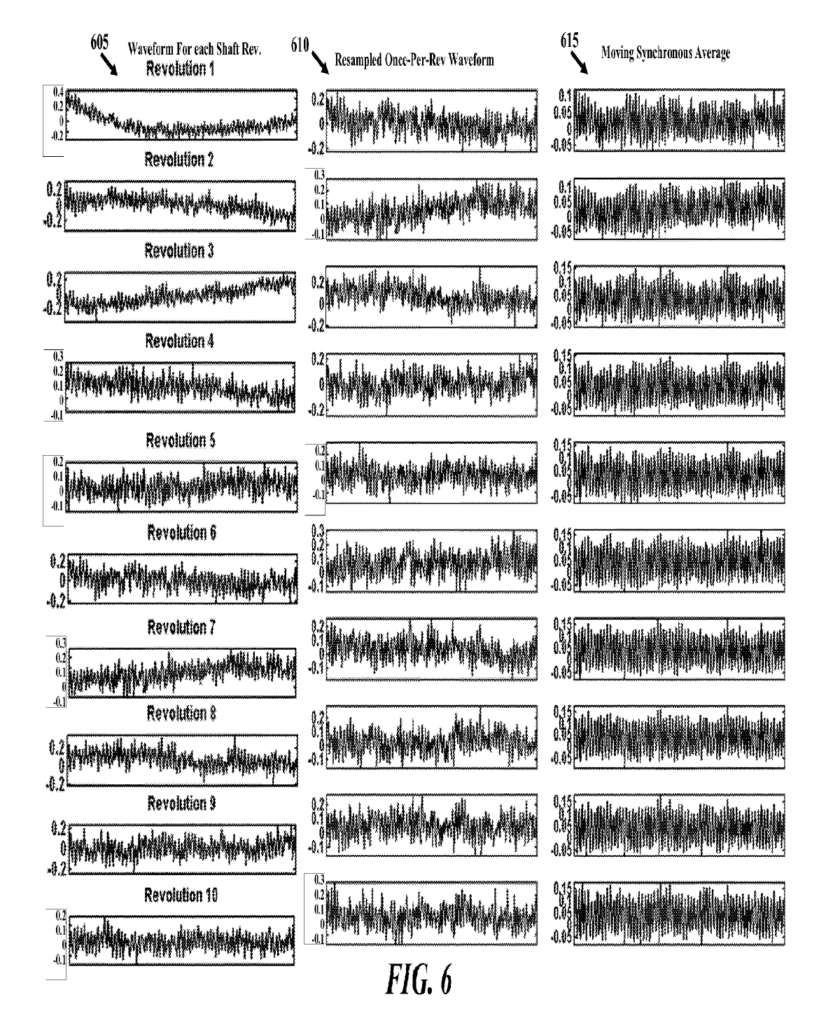

Referring now to FIG. 3, a graphical representation is depicted for indicating blade clearance according to one or more other embodiments. According to one or more embodiments, blade clearance may be determined by process flow 300 including receiving capacitive sensor data 305 and tachometer data 310. Angular resampling 315 may be performed based on the received capacitive sensor data 305 and tachometer data 310. As such, a waveform is determined for each shaft rotation (see FIG. 6). Based on angular resampling, the reciprocal standard deviation for each revolution waveform is determined at block 320. In certain optional embodiments, a moving synchronous average may be determined at block 321. According to one embodiment, a moving synchronous average may be employed to produce a time domain representation of the displacement signal over one shaft rotation for each rotation.

Computing a moving synchronous average at block 321 may include determining one or more of a standard deviation and peak-to-peak displacement of the moving synchronous average as an indication of blade clearance. The moving synchronous average may be determined as a scalar feature which is sensitive to mean tip clearance. Computing temperature compensation of the scalar feature to compensate for thermal sensitivity of the sensor.

A blade clearance indication at block 325 may be based on the determined standard deviation at block 320.

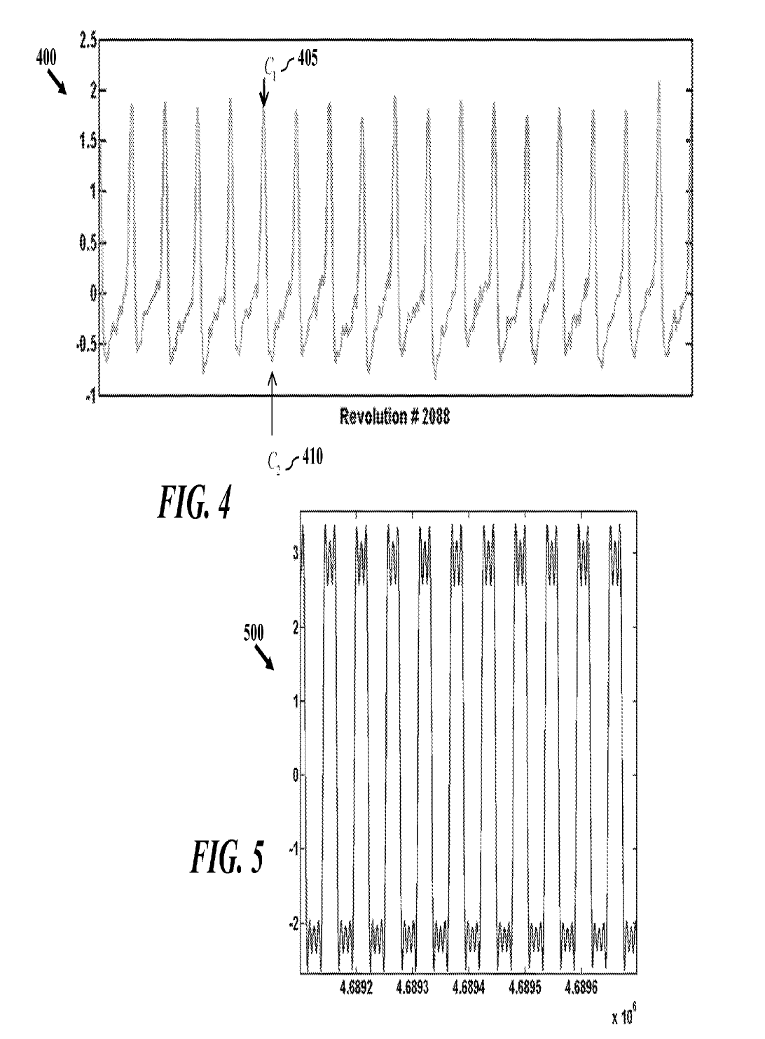

FIG. 4 depicts a graphical representation of displacement sensor output according to one or more other embodiments. According to one embodiment, the displacement sensor output 400 may include capacitance for when the blade tips is in direct view of the displacement sensor for the distance between the blade tip and the displacement sensor shown as 405. Displacement sensor output may represent capacitance when the tip is out of view, such as the distance between cap probe and nearest conductive surface shown as 410. According to one embodiment, it may be assumed that blade tip clearance is inversely proportional to peak to peak amplitude of the waveform.

FIG. 5 depicts a graphical representation of tachometer data according to one or more embodiments. Tachometer data 500 includes pulses produced at regular intervals.

FIG. 6 depicts a graphical representation of waveforms according to one or more embodiments. Waveform 605 may be determined for each shaft revolution. Waveform 610 may represent waveforms resampled from waveforms 605 once-per-revolution. Waveform 615 relate to a moving synchronous average for the resampled waveforms. Waveform 615 may relater to an exponentially weighted moving synchronous average. Waveforms 605, 610, and 615 may be determined and employed by an analysis unit for determining blade clearance.

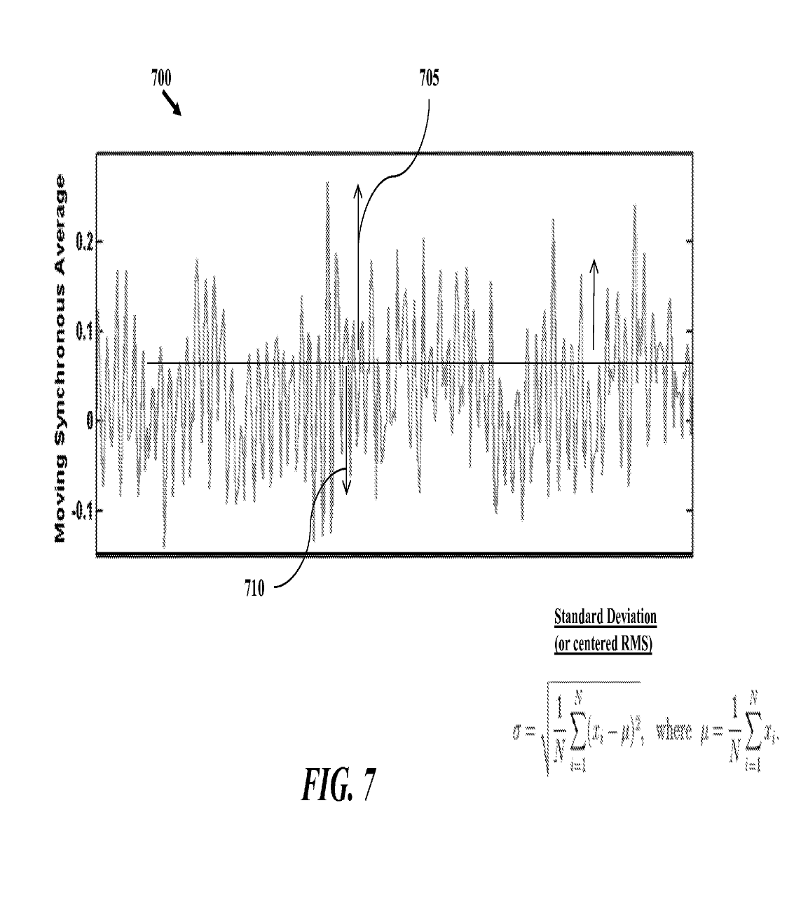

FIG. 7 depicts a graphical representation of moving synchronous average standard deviation according to one or more embodiments. Waveforms 700 relates to a moving synchronous average determined for a rotor element. The standard deviation of waveform 700 represented by 705 and 710 may be employed to determine blade clearance. Standard deviation may be a good indicator for amplitude for of periodic waveforms processed by an analysis unit.

While this disclosure has been particularly shown and described with references to exemplary embodiments thereof, it will be understood by those skilled in the art that various changes in form and details may be made therein without departing from the scope of the claimed embodiments.

What is claimed is:

1. A method for determining blade clearance for asymmetrical rotors, the method comprising the acts of:
detecting displacement data of a rotor blade coupled to a shaft;
receiving tachometer data determined for rotation speed of the shaft;
resampling the displacement data of the rotor blade based on the tachometer data, wherein resampling includes sampling the displacement data at constant increments of shaft rotation; and
determining blade clearance based on the resampled displacement data.

2. The method of claim 1, wherein the displacement data for the rotor blade includes blade length measurement data.

3. The method of claim 1, wherein displacement data for the rotor blade is instantaneous displacement data of the rotor blade determined by a capacitive sensor.

4. The method of claim 1, wherein the tachometer data is determined by a tachometer producing pulses at regular intervals.

5. The method of claim 1, wherein angular resampling generates a resampled waveform for each revolution of the rotor blade based on
determining zero up-crossings for the tachometer data,
determining an angle of shaft of interest at each up-crossing,
interpolating up-crossing angles to find shaft angle at all original sample times, and
interpolating the signal at equal angular increments.

6. The method of claim 1, further comprising computing a moving synchronous average to produce a time domain representation of the displacement signal over one shaft rotation for each rotation.

7. The method of claim 6, wherein computing the moving synchronous average includes determining one or more of a standard deviation and peak-to-peak displacement of the moving synchronous average as an indication of blade clearance.

8. The method of claim 7, wherein the moving synchronous average is determined as a scalar feature which is sensitive to mean tip clearance.

9. The method of claim 8, further comprising computing temperature compensation of the scalar feature to compensate for thermal sensitivity of the sensor.

10. The method of claim 1, wherein displacement data for the rotor blade is output for control of a gas turbine engine.

11. A system for determining blade clearance for asymmetrical rotors comprising:
a displacement sensor configured to detect displacement data of a rotor blade coupled to a shaft;
a tachometer configured to output tachometer data for rotation speed of the shaft;
an analysis unit coupled to the displacement sensor and tachometer, the analysis unit configured to
resample the displacement data of the rotor blade based on the tachometer data, wherein resampling includes sampling the displacement data at constant increments of shaft rotation; and
output an indication of blade clearance based on the resampled displacement data.

12. The system of claim 11, wherein the displacement data for the rotor blade includes blade length measurement data.

13. The system of claim 11, wherein displacement data for the rotor blade is instantaneous displacement data of the rotor blade determined by a capacitive sensor.

14. The system of claim 11, wherein the tachometer produces pulses at regular intervals.

15. The system of claim 11, wherein angular resampling generates a resampled waveform for each revolution of the rotor blade based on the analysis unit
determining zero up-crossings for the tachometer data,
determining an angle of shaft of interference at each up-crossing,
interpolating up-crossing angles to find shaft angle at all original sample times, and
interpolating the signal at equal angular increments.

16. The system of claim 11, further comprising computing a moving synchronous average to produce a time domain representation of the displacement signal over one shaft rotation for each rotation.

17. The system of claim 16, wherein computing the moving synchronous average includes determining one or more of a standard deviation and peak-to-peak displacement of the moving synchronous average as an indication of blade clearance.

18. The system of claim 17, wherein computing the moving synchronous average is determined as a scalar feature which is sensitive to mean tip clearance.

19. The system of claim 18, further comprising computing temperature compensation of the scalar feature to compensate for thermal sensitivity of the sensor.

20. The system of claim 11, wherein displacement data for the rotor blade is output for control of a gas turbine engine.
